(19) United States
(12) Patent Application Publication
(10) Pub. No.: US 2004/0217087 A1
(43) Pub. Date: Nov. 4, 2004

(54) Boron trichloride-based plasma etch

(76) Inventors: Francis G. Celii, Dallas, TX (US); Mahesh Thakre, Dallas, TX (US); Scott R. Summerfelt, Garland, TX (US); Theodore S. Moise, Dallas, TX (US)

Correspondence Address: TEXAS INSTRUMENTS INCORPORATED, P O BOX 655474, M/S 3999, DALLAS, TX, 75265

(21) Appl. No.: 10/426,502

(22) Filed: Apr. 30, 2003

(51) Int. Cl. C23F 1/00; B44C 1/22; C03C 25/68; C03C 15/00

(52) U.S. Cl. 216/67

(57) ABSTRACT

An embodiment of the invention is a method of eliminating the surface roughness of the hardmask 4 of a ferroelectric capacitor stacks 2 using a BCl₃-based plasma etch.

### BACKGROUND OF THE INVENTION

This invention relates to a method for removing the surface roughness of the hardmask located on top of the ferroelectric capacitor stacks in ferroelectric random access memories.

### BRIEF DESCRIPTION OF THE DRAWINGS

FIG. 1 is a cross-section view of a ferroelectric capacitor stack after the capacitor definition etch.

FIG. 2 is a cross-section view of a ferroelectric capacitor stack after the capacitor isolation etch and surface smoothing etch in accordance with the present invention.

### DETAILED DESCRIPTION OF THE INVENTION

The present invention is described with reference to the attached figures, wherein similar reference numerals are used throughout the figures to designate like or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One skilled in the relevant art, however, will readily recognize that the invention can be practiced without one or more of the specific details or with other methods. In other instances, well-known structures or operations are not shown in detail to avoid obscuring the invention.

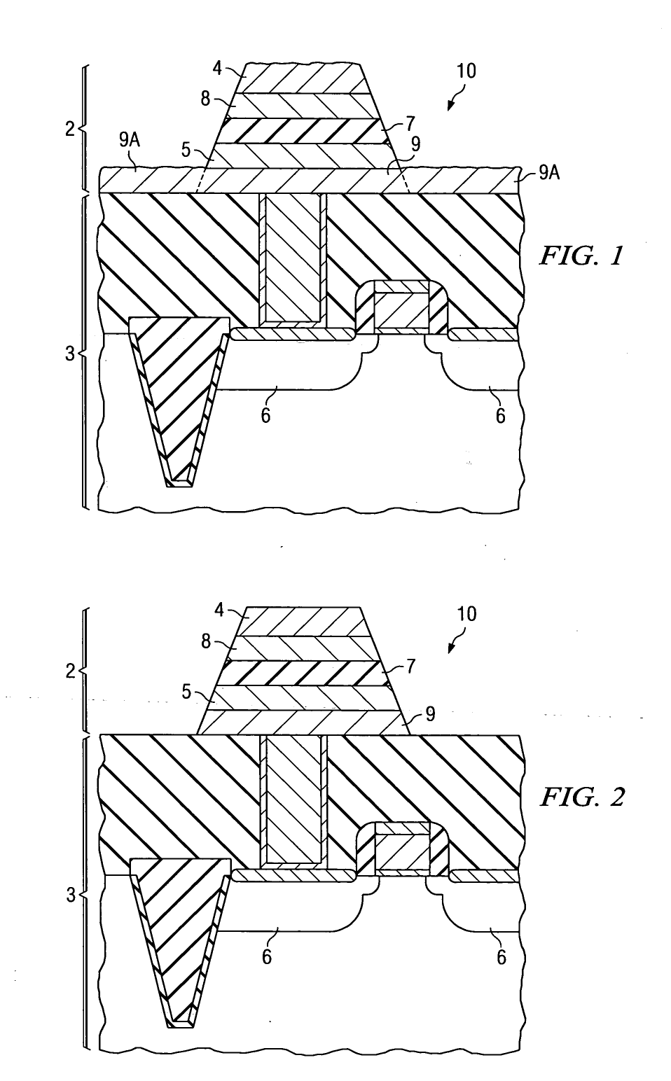

Referring to the drawings, FIG. 1 depicts a cross-section view of a ferroelectric capacitor stack 2 after the capacitor definition etch. The ferroelectric capacitor stack 2 is located within a ferroelectric random access memory (“FRAM”) array. In turn, the FRAM array is located between the standard logic front-end 3 and back-end (not shown) of an integrated circuit. The front-end 3 of the wafer (i.e. the portion closest to the substrate) contains the transistor logic while the FRAM array contains non-volatile memory. The device's interconnects and metal lines —used to move electrical signals and power throughout the device —are contained in the back-end portion of the integrated circuit (i.e. fabricated over the FRAM array). Other than the best mode process for eliminating the surface roughness of the hardmask 4 of the ferroelectric capacitor stack 2 (described herein), the processing steps for creating the ferroelectric memory array is any known process, such as those described in commonly assigned patents Pat. No. 6,548,343 (Ser. No. 09/702,985, TI Docket Number TI-29970, filed Oct. 31, 2000), 6,492,222 (Ser. No. 09/739,065, TI Docket Number TI-29966, filed Dec. 18, 2000), and 6,444,542 (Ser. No. 09/826,283, TI Docket Number TI-26585, filed Apr. 3, 2001), incorporated herein by reference and not admitted to be prior art with respect to the present invention by their mention in this section.

In the example application, a diffusion barrier layer 9 is formed over the semiconductor wafer 10 after the fabrication of the front-end module 3 but prior to the fabrication of the FRAN memory array. The diffusion barrier 9 may be formed by a reactive sputter deposition of TiAlN; however, other deposition techniques or barrier materials may be used. For example, instead of using TiAlN as the diffusion barrier material, either TiN, or Ru, or a stack having any combination of these three materials may be used.

In general, a single capacitor memory cell (referred to as a “1T/1C” or “1C” memory cell) has one transistor and one storage capacitor. Furthermore, as shown in FIG. 1, the bottom electrode 5 of the storage capacitor is generally electrically connected to the drain 6 of a transistor. In the example application shown in FIG. 1, the FRAM memory array is located between the front-end module and the back-end module. However, other locations for the FRAM memory array are within the scope of this invention. For example, the FRAM array may be placed over the first level of metallization or near the end of the back-end module. Furthermore, it is within the scope of this invention to have a FRAM array containing a dual capacitor memory cell (comprising two transistors and two ferroelectric capacitors) instead of a single capacitor memory cell.

The FRAM memory array contains numerous FRAM memory cells. The ferroelectric capacitor 2 contained within the ferroelectric memory cell is comprised of ferroelectric material, such as lead zirconate titanate (called “PZT” based on its chemical formula: Pb(Zr, Ti)O₃) that functions as a capacitor dielectric, 7, situated between a bottom electrode, 5, and a top electrode, 8. In example application, the bottom electrode, 5, is comprised of Ir, Pt, IrO₂, SrRuO₃, or a stack thereof. Similarly, the top electrode, 8, is comprised of Ir, Pt, IrO₂, SrRuO₃, or a stack thereof, and is not necessarily the identical material/stack as the bottom electrode.

A hardmask layer 4 is formed over the material stack (i.e. the diffusion barrier 9, the bottom electrode 5, the ferroelectric 7, and the top electrode 8) in order to facilitate proper shaping of the ferroelectric capacitor. The hardmask is comprised of a material that is thick enough to retain its integrity during all etch processes. Furthermore, the hardmask is comprised of one or more layers of conductive material in order to electrically couple the top electrode 8 with the rest of the FRAM array and/or the back-end module. In the best mode application, the hardmask 4 is comprised of a top and bottom layer of TiAlN separated by a layer of TiAlON; however the hardmask may be comprised of TiN, AlN, Ta, TaN, Cr, CrN, Zr, ZrN, Hf, HfN, or any stack or combination thereof.

Multiple etch processes such as those described in the incorporated references are used to achieve the initial capacitor definition shown in FIG. 1. Thereafter a capacitor isolation etch is performed to remove portions 9A of the diffusion barrier 9 outside the parameter of the ferroelectric capacitor stack. Initially, Ar/BCl₃ may be used as the etchant in a plasma etch process to dissolve the oxide crust that probably exists on the diffusion barrier portion 9A following the capacitor definition etch. Then an Ar/Cl₂ etchant may be used in a plasma etch process to remove the unwanted diffusion barrier material 9A (thereby electrically isolating each ferroelectric capacitor stack 2 from the other ferroelectric capacitor stacks in the FRAM array).

Referring again to the drawings, FIG. 2 shows the structure of the ferroelectric capacitor stack 2 after the isolation etch has removed the unwanted portions 9A of the diffusion barrier 9. Note that the top TiAlN 4 will survive the bottom TiAlN 9 strip due to its thickness. In accordance with the best mode application, a plasma clean up etch is now performed to remove the surface roughness that was created on the surface of the hardmask 4 during the previous process steps. The surface roughness of the hardmask 4 is comprised of oxidized regions of the TiAlN hardmask, as well as deposited regions of TiAlON (formed during previous etch processes). The removal of surface roughness using this invention will improve the electrical connection between the ferroelectric capacitor 2 and the rest of the FRAM array and/or back-end module.

In accordance with this invention, a BCl-based plasma etch is performed to eliminate the surface roughness of the hardmask. More specifically, in the best mode application, the hardmask 4 (or specifically the top layer of hardmask 4) is Ti_{0.6}Al_{0.4}N, and an Ar/BCl₃ chemistry is used in a plasma etch process under standard conditions for anisotropic etching.

The surface smoothing clean up etch described above may be performed in any well known plasma etch machine, such as the inductively coupled plasma (“ICP”) etcher manufactured by Applied Materials. For this particular etch machine, and for the example structure shown in FIG. 1, the best mode etch application uses low pressure (˜10 mTorr), moderate source power (i.e. 1000 W), high bias power (i.e. 750 W), a low temperature (˜60° C.), and for a moderate period of time (˜30 seconds).

The following table shows a range of etch recipe parameters:

| | Ar | Cl2 | BCl3 | Press** | Ps** | Pb** | Time(s)* |
|---|---|---|---|---|---|---|---|
| Current BL | | | | | | | |
| Breakthrough | 60 | | 40 | 10 | 1000 | 750 | 10 |
| TiAlN | 50 | 70 | | 8 | 1000 | 150 | ˜35* |
| HM C/U | 60 | | 40 | 10 | 1000 | 750 | 30 |
| Ranges | | | | | | | |
| Breakthrough | 5-200 | 0-50 | 20-200 | 5 to 50 | 500-1500 | 500-1500 | 5-30 |
| TiAlN | 5-200 | 10-200 | 0-200 | 5 to 50 | 500-1500 | 50-500 | 20-60* |
| HM C/U | 5-200 | 0-50 | 20-200 | 5 to 50 | 500-1500 | 500-1500 | 10-60 |

**Depends on tool
*Depends on layer thickness
Notes:
“BL” stands for Base Line process.
“HM C/U” means Hard Mask plasma Clean Up.

It should be noted that the same chamber of the plasma etch machine may be used for more than one of the above described etch processes. Furthermore, it is within the scope of this invention to use any BCl-based etch chemistry to eliminate the surface roughness of the hardmask 4. Moreover, other etch chemistries may be used that will etch the oxidized portions of the hard mask, such as SF₆-based etch chemistries.

Other modifications to the invention as described above are within the scope of the claimed invention. As an example, instead of using PZT as the ferroelectric material, other materials such as SrBi₂Ta₂O₉ may be used. In addition, instead of using this invention to fabricate planar ferroelectric capacitors, it may be used to fabricate the three dimensional cup-shaped capacitor. As an example, this invention could be used to fabricate capacitor under bitline structures.

It is within the scope of this invention to use the BCl₃-based plasma etch to smooth the surface of hardmasks used to fabricate gate electrodes or any other metal component of the integrated circuit. This invention can be used in the fabrication of stand-alone FRAM devices or FRAM devices integrated into a semiconductor chip that has many other device functions than those described herein. Furthermore, instead of forming the bottom electrode, 5, on the barrier layer, 9, the bottom electrode, 5, may be formed directly on the front-end module 3. Moreover, the invention is applicable to semiconductor wafers having different well and substrate technologies, transistor configurations, and metal connector materials or configurations. The invention is also applicable to other semiconductor technologies such as BiCMOS, bipolar, SOI, strained silicon, pyroelectric sensors, opto-electronic devices, microelectrical mechanical system (“MEMS”), or SiGe.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A method of cleaning, by etching a material stack having a hardmask top layer with a plasma-activated etchant, the improvement consisting of
a BCl₃-based etchant.

2. The method of claim 1 wherein said etching is done at a temperature between 30-180° C.

3. The method of claim 1 wherein said etching is done with a source power between 500-1500 W and a bias power between 200-1000 W.

4. The method of claim 1 wherein said hardmask top layer comprises TiAlN.

5. A method of cleaning by etching a material stack having a hardmask top layer with a plasma-activated etchant, the improvement consisting of:
an Ar/BCl₃-based etchant.

6. The method of claim 5 wherein said hardmask top layer comprises TiAlN.

7. A method of cleaning by etching a material stack having a hardmask top layer with a plasma-activated etchant, the improvement consisting of:
a Cl₂/BCl₃-based etchant.

8. The method of claim 7 wherein said hardmask top layer comprises TiAlN.

9. A method of cleaning, by etching a material stack having a hardmask top layer with a plasma-activated etchant, the improvement consisting of:
a BCl-based etchant.

10. The method of claim 9 wherein said hardmask top layer comprises TiAlN.

11. A method of performing plasma clean up of a material stack having a hardmask top layer comprising:
etching said material stack with a BCl₃-based plasma etchant.

12. The method of claim 11 wherein said material stack is a ferroelectric capacitor.

13. The method of claim 11 wherein said material stack is a gate.

14. The method of claim 11 wherein said BCl₃-based plasma etchant is Ar/BCl₃.

15. The method of claim 11 wherein said BCl₃-based plasma etchant is Ar/Cl₂/BCl₃.

16. The method of claim 11 wherein said etching is done at a temperature between 30-180° C.

17. The method of claim 11 wherein said etching is done at a source power between 500-1500 W and a bias power between 200-1000 W.

18. The method of claim 11 wherein said hardmask top layer comprises TiAlN.

19. A method of performing plasma clean up of a material stack having a hardmask top layer comprising:
etching said material stack with an SF₆-based plasma etchant.

20. The method of claim 19 wherein said material stack is a ferroelectric capacitor.

21. A method of performing plasma clean up of a material stack having a hardmask top layer comprising:
a first etch of said material stack with a Ar/BCl₃ plasma etchant;
a second etch of said material stack with an Ar/Cl₂ plasma etchant; and
a third etch of said material stack with a Ar/BCl₃ plasma etchant.

22. The method of claim 21 wherein said material stack is a ferroelectric capacitor.

23. The method of claim 21 wherein said material stack is a gate.

24. The method of claim 21 wherein said first etch is at a temperature between 30-180° C., a source power between 500-1500 W, and a bias power between 200-1000 W.

25. The method of claim 21 wherein said second etch is at a temperature between 30-180° C., a source power between 500-1500 W, and a bias power between 200-1000 W.

26. The method of claim 21 wherein said third etch is at a temperature between 30-180° C., a source power between 500-1500 W, and a bias power between 200-1000 W.

27. The method of claim 21 wherein said hardmask top layer comprises TiAlN.

28. A process for smoothing a surface of a hardmask top layer of a ferroelectric capacitor structure, comprising:
etching the surface of said hardmask top layer with a BCl₃-based plasma etchant.

29. The process of claim 28 wherein said BCl₃-based plasma etchant is Ar/BCl₃.

30. The process of claim 28 wherein said BCl₃-based plasma etchant is Ar/Cl₂/BCl₃.

31. The process of claim 28 wherein said etching is at a temperature between 30-180° C., a source power between 500-1500 W, and a bias power between 200-1000 W.

32. The method of claim 28 wherein said hardmask top layer comprises TiAlN.

33. A process for smoothing a hardmask top layer of a gate structure, comprising:
etching the surface of said hardmask top layer with a BCl₃-based etchant.

34. The method of claim 33 wherein said hardmask top layer comprises TiAlN.

35. A process for removing oxidized regions of a TiAlN hardmask, which comprises:
etching the surface of said hardmask with a BCl₃-based etchant.

36. The process of claim 35 wherein said BCl₃-based plasma etchant is Ar/BCl₃.

37. The process of claim 35 wherein said BCl₃-based plasma etchant is Ar/Cl₂/BCl₃.

38. The process of claim 35 wherein said etching is at a temperature between 30-180° C., a source power between 500-1500 W, and a bias power between 200-1000 W.
